(19) United States
(12) Patent Application Publication
(10) Pub. No.: US 2006/0164582 A1
(43) Pub. Date: Jul. 27, 2006

(54) Thin film transistor array panel, liquid crystal display including the panel and manufacturing method thereof

(75) Inventors: Seong-Ho Kim, Gyeonggi-do (KR); Gyung-Soon Park, Gyeonggi-do (KR); Kyung-Min Park, Gyeonggi-do (KR); Seung-Gon Kang, Gyeonggi-do (KR); Chun-Gi You, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/341,555

(22) Filed: Jan. 26, 2006

(30) Foreign Application Priority Data
Jan. 26, 2005 (KR) 10-2005-0007125

(51) Int. Cl. G02F 1/1333

(52) U.S. Cl. 349/122

(57) ABSTRACT

A thin film transistor array panel is provided, which includes: a substrate having a display area including a plurality of display areas, and a peripheral area surrounding the display area; a plurality of thin film transistors respectively formed in the pixel areas; a passivation layer made of organic material and covering the thin film transistors; a plurality of pixel electrode respectively connected to the thin film transistors and formed on the passivation layer of the pixel areas; an organic light blocking member formed with the same layer as the pixel electrode and disposed in the peripheral area; and a sealant surrounding the display area, the sealant being formed on the passivation layer in the peripheral area. The organic blocking member overlaps the sealant.

### BACKGROUND OF THE INVENTION

(a) Field of the Invention

The present invention relates to a thin film transistor array panel, a liquid crystal display using the panel and a manufacturing method thereof.

(b) Description of Related Art

A liquid crystal display (“LCD”) is one of the most prevalent flat panel displays, which includes two panels having field-generating electrodes and a liquid crystal layer interposed therebetween and controls the transmittance of light passing through the liquid crystal layer by adjusting voltages applied to the electrodes to re-arrange liquid crystal molecules in the liquid crystal layer.

Among LCDs including field-generating electrodes on respective panels, a kind of LCDs provides a plurality of pixel electrodes arranged in a matrix at one panel and a common electrode covering an entire surface of the other panel. The image display of the LCD is accomplished by applying individual voltages to the respective pixel electrodes. For the application of the individual voltages, a plurality of three-terminal thin film transistors (TFTs) are connected to the respective pixel electrodes, and a plurality of gate lines transmitting signals for controlling the TFTs and a plurality of data lines transmitting voltages to be applied to the pixel electrodes are provided on the panel.

The TFT includes a semiconductor layer of amorphous silicon or polysilicon, and is classified into a top gate type and a bottom type according to the relative positions of the gate electrode and the semiconductor layer. In the case of the TFT including polysilicon as the semiconductor layer, the TFT of top gate type is generally used. In the TFT of top gate type, the semiconductor layer of polysilicon is formed on an insulating layer, and a gate line and a storage electrode line are formed on a gate insulating layer covering the semiconductor layer.

The polysilicon TFT has the relatively high electron mobility relative to an amorphous silicon TFT, and the polysilicon TFT enables the implementation of a COG (chip on glass) technique which provide display panel having high quality along with high resolution.

In a thin film transistor array panel using polysilicon, a passivation layer made of organic material having low dielectric ratio is used as an interlayer insulator. However, many problems such as afterimages and spot neighboring an injection hole of liquid crystal are generated due to the organic insulating layer.

More particularly, because the organic insulating layer neighboring the edge of the thin film transistor array is exposed from the pixel electrode, the exposed organic insulating layer is directly contacted with the liquid crystal material after assembling the two panels and injecting the liquid crystal material. Particularly, because the organic insulating layer neighboring an injection hole is exposed from a sealant enclosing an liquid crystal layer between two panels, the exposed organic insulating layer is damaged by ultraviolet rays when the sealant is hardened using ultraviolet rays. This results in spots being generated neighboring the injection hole. Furthermore, the organic material damaged by ultraviolet rays dissolves into the liquid crystal layer, and the dissolved organic material produces a delay in the response time of liquid crystal, resulting in afterimages. Such problems occur in a manufacturing process using high temperature.

### SUMMARY OF THE INVENTION

A thin film transistor array panel is provided, which includes: a substrate having a display area including a plurality of display areas, and the peripheral area enclosing the display area; a plurality of thin film transistors respectively formed in the pixel areas; a passivation layer made of organic material and covering the thin film transistors; a plurality of pixel electrode respectively connected to the thin film transistors and formed on the passivation layer of the pixel areas; an organic blocking member formed with the same layer as the pixel electrode and disposed in the peripheral area; and a sealant enclosing the display area and formed on the passivation layer of the peripheral area, wherein the organic blocking member overlaps the sealant.

The organic blocking member may be made of the same material as the pixel electrode.

The sealant may have one side having an injection hole.

The organic blocking member may overlap the side having the injection hole.

A liquid crystal display is provided, which includes: a first substrate having a display area including a plurality of display areas and the peripheral area enclosing the display area; a plurality of thin film transistors respectively formed in the pixel areas on the first substrate; a passivation layer made of organic material and covering the thin film transistors; a plurality of pixel electrode respectively connected to the thin film transistors and formed on the passivation layer of the pixel areas; an organic blocking member formed with the same layer as the pixel electrode and disposed in the peripheral area; a sealant enclosing the display area and formed on the passivation layer of the peripheral area; a second substrate facing the first substrate; and a liquid crystal layer formed the first and the second substrates, and sealing by the sealant, wherein the organic blocking member overlaps the sealant.

The sealant may have one side having an injection hole.

The organic blocking member may overlap the sealant of the side having the injection hole.

A final sealant made of ultraviolet hardening material may be formed in the injection hole.

A method of manufacturing a liquid crystal display is provided, which includes: forming a plurality of thin film transistors in a display area on a first substrate having a display area and the peripheral area enclosing the display area; forming a passivation layer made of organic material and covering the thin film transistors; forming a plurality of pixel electrode on the passivation layer of the display areas, and an organic blocking member in the peripheral area; and forming a sealant enclosing the display area on the passivation layer of the peripheral area, wherein one side of the sealant overlaps the organic blocking member.

The method may further includes: assembling the first substrate and a second substrate facing the first substrate using the sealant; injecting a liquid crystal material through an injection hole of the sealant between the first and the second substrates; forming a final sealant at the injection hole; and hardening the final sealant using ultraviolet rays.

The organic blocking member may be disposed on the injection hole.

### BRIEF DESCRIPTION OF THE DRAWINGS

The present invention will become more apparent in light of the detailed description below taken with the accompanying drawings in which:

FIG. 1 is a plan layout view of a thin film transistor array panel according to an embodiment of the present invention;

FIG. 2 is a sectional view of an LCD including the thin film transistor array panel shown in FIG. 1, and taken along the line II-II;

FIG. 3 is a plan layout view of a TFT array panel according to an embodiment of the present invention;

FIG. 4 is a sectional view of the display area shown in FIG. 3 taken along lines 4-4;

FIG. 5 is a cross sectional view of the TFT array panel shown in FIGS. 3 and 4 in the first step of a manufacturing method thereof according to an embodiment of the present invention;

FIG. 6 is a layout view of the TFT array panel shown in FIGS. 3 and 4 in the first step of a manufacturing method thereof according to an embodiment of the present invention and illustrates the step following the step shown in FIG. 5;

FIG. 7 is a sectional view of the TFT array panel shown in FIG. 6 taken along the line VII-VII;

FIG. 8 a sectional view of the TFT array panel shown in FIG. 6 taken along the line VII-VII, and illustrates the step following the step shown in FIGS. 6 and 7;

FIG. 9 is a sectional view of the TFT array panel shown in FIG. 6 taken along the line VII-VII, and illustrates the step following the step shown in FIG. 8;

FIG. 10 is a layout view of the TFT array panel in the step following the step shown in FIG. 9;

FIG. 11 is a sectional view of the TFT array panel shown in FIG. 10 taken along the line XI-XI;

FIG. 12 is a layout view of the TFT array panel in the step following the step shown in FIGS. 10 and 11;

FIG. 13 is a sectional view of the TFT array panel shown in FIG. 12 taken along the line XIII-XIII;

FIG. 14 is a layout view of the TFT array panel in the step following the step shown in FIGS. 12 and 13;

FIG. 15 is a sectional view of the TFT array panel shown in FIG. 14 taken along the line XV-XV;

FIG. 16 is a layout view of the TFT array panel in the step following the step shown in FIGS. 14 and 15; and

FIG. 17 is a sectional view of the TFT array panel shown in FIG. 14 taken along the line XVII-XVII.

### DETAILED DESCRIPTION OF EMBODIMENTS

The present invention is described more fully below with reference to the accompanying drawings, in which preferred embodiments of the invention are shown. This invention may, however, be embodied in many different forms and should not be construed as limited to the embodiments set forth herein. Like numerals refer to like elements throughout.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, thin film transistor array panel, liquid crystal display including the same and method of manufacturing the same according to embodiments of the present invention will be described with reference to the accompanying drawings.

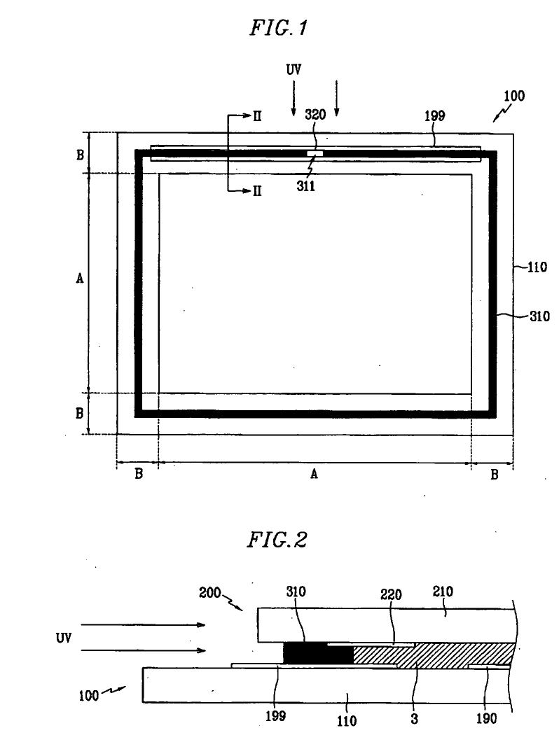

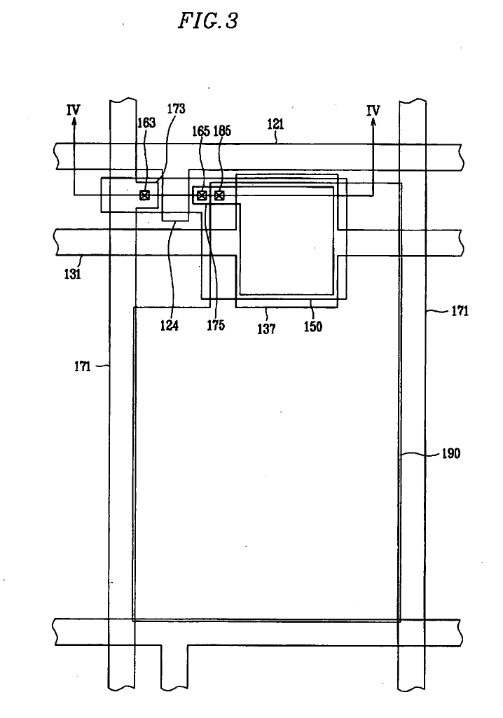

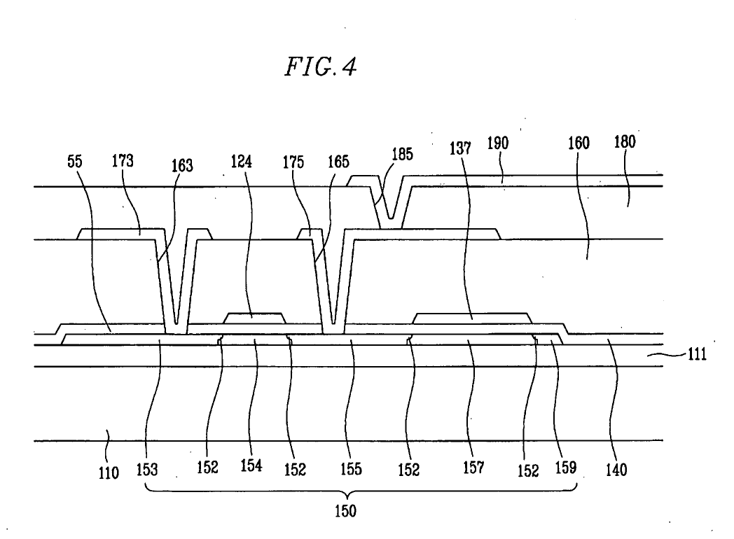

FIG. 1 is a layout view of a thin film transistor array panel according to an embodiment of the present invention, FIG. 2 is a sectional view of an LCD including the thin film transistor array panel shown in FIG. 1, and taken along the line II-II. FIG. 3 is a layout view of a TFT array panel according to an embodiment of the present invention, and FIG. 4 is a sectional view of the display area shown in FIG. 3 taken along the lines IV-IV.

As shown in FIGS. 1 and 2, an LCD according to an embodiment of the present invention includes an upper panel 200 and a lower panel 100 facing each other with a liquid crystal layer 3 interposed therebetween. The LCD further includes a sealant 310 formed around the periphery of panels 100 and 200 and between panels 100 and 200. The sealant 310 seals the liquid crystal layer 3 between two panels 100 and 200 and seals panels 100 and 200 to each other.

The lower panel 100 includes a display area A which displays images and a peripheral area B which is located in circumference of the display A. A plurality of signal lines such as a plurality of gate lines 121 and a plurality of data lines 171, which intersect each other to define a plurality of pixel areas arranged in a matrix, are formed in the lower panel 100. In each pixel area, a TFT connected to the gate and the data lines 121 and 171, and a pixel electrode 190 electrically connected to the TFT are provided. The plurality of pixel areas forms a display area A. A passivation layer 180 made of organic material having low dielectric ratio is formed between the signal lines and the pixel electrodes 190 to make an interlayer insulator therebetween, and the passivation layer 180 covers all of the area of the lower panel 100.

An organic blocking member is formed from the same layer of material as is the pixel electrode 190. The organic blocking member 199 is spaced apart from the pixel electrode 190 by a predetermined distance and is located at the peripheral area B.

The sealant 310 is formed on the passivation layer 180 in the peripheral area B, and surrounds the display area A. As shown in FIGS. 1 and 2, organic blocking member 199 overlaps the portion of sealant 310 along the top side of panel 100.

More particularly, the sealant 310 includes four sides formed according to the four sides of the lower panel 100, and the organic blocking member 199 overlaps the one side of the sealant 310 which includes injection hole 311 used to inject a liquid crystal material. The injection hole 311 is filled with a final sealant 320 after injecting liquid crystal material between the two panels 100 and 200. The final sealant 320 is made of ultraviolet hardening material.

As described above, the organic light blocking member 199 is located on the organic layer 180 on which the injection hole 311 of the sealant 310 and the final sealant 320 is formed. Accordingly, the organic light blocking member 199 prevents the organic layer 180 neighboring the injection hole 311 from being damaged by ultraviolet radiation used to harden the final sealant 320. Furthermore, the organic blocking light member 199 prevents spot defects generated by heat which impacts the circumference of the injection hole 311.

Furthermore, the organic blocking member 199 may remove the organic material of the passivation layer 180 which is polluted by ultraviolet irradiation and is dissolved into the liquid crystal layer 3 by preventing the organic layer 180 neighboring the injection hole 311 from being damaged by ultraviolet irradiation, thereby enhancing a response time of liquid crystal and minimizing afterimages.

Next, the pixel area of the TFT array panel for an LCD according to an embodiment of the present invention is described below in detail with reference to FIGS. 3 and 4.

Referring to FIG. 4, a blocking film 111, preferably made of silicon oxide (SiO₂) or silicon nitride (SiNx) is formed on an insulating substrate 110, which may be transparent glass, quartz or sapphire.

A plurality of semiconductor islands 150 preferably made of polysilicon are formed on the blocking film 111. Each of the semiconductor islands 150 includes a plurality of extrinsic regions containing N type or P type conductive impurity and at least one intrinsic region hardly containing conductive impurity.

The blocking layer 111 increases contact characteristics between the semiconductors 150 and the insulating substrate 110, and prevent impurities of the insulating substrate 110 from diffusing into the semiconductors 150 in a manufacturing process.

Concerning a semiconductor island 150, the intrinsic regions include a channel region 154 and a storage region 157, and the extrinsic regions are doped with N type impurity such as phosphorous (P) and arsenic (As) or P type impurity such as boron (B) and gallium (Ga), and include a plurality of heavily doped regions such as source and drain regions 153 and 155 separated from each other with respect to the channel region 154 and dummy regions 159 and a plurality of lightly doped regions 152 disposed between the intrinsic regions 154 and 157 and the heavily doped regions 153, 155 and 159.

The lightly doped regions 152 have relatively small thickness and length compared with the heavily doped regions 153, 155 and 159 and are disposed close to surfaces of the semiconductor islands 150. The lightly doped regions 152 disposed between the source region 153 and the channel region 154 and between the drain region 155 and the channel region 154 are referred to as “lightly doped drain (LDD) regions” and they prevent leakage current of TFTs.

A gate insulating layer 140 having a thickness of more than 2,000 □ is formed on the on the semiconductor islands 150.

A plurality of gate conductors including a plurality of gate lines 121 and a plurality of storage electrode lines 131 are formed on the gate insulating layer 140, respectively.

The gate lines 121 for transmitting gate signals extend substantially in a transverse direction and include a plurality of gate electrodes 124 protruding downward to overlap the channel areas 154 of the semiconductor islands 150. Each gate line 121 may include an expanded end portion having a large area for contact with another layer or an external driving circuit. The gate lines 121 may be directly connected to a gate driving circuit for generating the gate signals, which may be integrated on the substrate 110.

The storage electrode lines 131 are supplied with a predetermined voltage such as a common voltage and include a plurality of storage electrodes 137 protruding upward and downward and overlapping the storage regions 157 of the semiconductor islands 150.

The gate lines 121 and the storage electrode lines 131 are preferably made of Al containing metal such as Al and Al alloy, Ag containing metal such as Ag and Ag alloy. The gate lines 121 and the storage electrode lines 131 may have a multi-layered structure including two films having different physical characteristics. One of the two films is preferably made of low resistivity metal including above described conductive material for reducing signal delay or voltage drop in the gate lines 121 and the storage electrode lines 131. The other film is preferably made of material such as Cr, Mo and Mo alloy, Ta or Ti, which has good physical, chemical, and electrical contact characteristics with other materials such as indium tin oxide (ITO) or indium zinc oxide (IZO). Good examples of the combination of the two films are a lower Cr film and an upper Al (Al—Nd alloy) film.

An interlayer insulating layer 160 is formed on the gate conductors 121 and 131. The interlayer insulating layer 160 is preferably made of inorganic material such as silicon nitride and silicon oxide. The interlayer insulating layer 160 may have double layered structure of SiO₂/SiNₓ to enhance the reliability of thin film transistor compared with single layered structure of SiO₂.

The interlayer insulating layer 160 has a plurality of contact holes 163 and 165 exposing the source regions 153 and the drain regions 155.

A plurality of data conductors including a plurality of data lines 171 and a plurality of drain electrodes 175 are formed on the interlayer insulating layer 160.

The data lines 171 for transmitting data voltages extend substantially in the longitudinal direction and intersect the gate lines 121 to define the pixel area. Each data line 171 includes a plurality of source electrodes 173 connected to the source regions 153 through the contact holes 163. Each data line 171 may include an expanded end portion having a large area for contact with another layer or an external driving circuit. The data lines 171 may be directly connected to a data driving circuit for generating the gate signals, which may be integrated on the substrate 110.

The drain electrodes 175 are separated from the source electrodes 173 and connected to the drain regions 155 through the contact holes 165.

The data conductors 171 and 175 are preferably made of material such as Cr, Mo and Mo alloy, Ta or Ti, which has good physical, chemical, and electrical contact characteristics with other materials such as indium tin oxide (ITO) or indium zinc oxide (IZO). The data conductors 171 and 175 may include Al containing metal such as Al and Al alloy, Ag containing metal such as Ag and Ag alloy, and have a multi-layered structure two films including one preferably made of above described conductive material, and other film preferably made of Cr, Mo and Mo alloy, Ta or Ti.

A passivation layer 180 is formed on the data conductors 171 and 175 and the interlayer insulating layer 160. The passivation layer 180 is also preferably made of photosensitive organic material having a good flatness characteristic, and low dielectric.

The passivation layer 180 has a plurality of contact holes 185 exposing the drain electrodes 175. The passivation layer 180 may further has a plurality of contact holes (not shown) exposing end portions of the data lines 171 and the passivation layer 180 and the interlayer insulating layer 160 may have a plurality of contact holes (not shown) exposing end portions of the gate lines 121.

A plurality of pixel electrodes 190, which are preferably made of at least one of transparent conductor such as ITO or IZO and opaque reflective conductor such as Al or Ag, are formed on the passivation layer 180.

The pixel electrodes 190 are physically and electrically connected to the drain electrodes 175 through the contact holes 185 such that the pixel electrodes 190 receive the data voltages from the drain regions 155 via the drain electrodes 175.

A plurality of contact assistants or connecting members (not shown) may be also formed on the passivation layer 180 such that they are connected to the exposed end portions of the gate lines 121 or the data lines 171.

At this time, the passivation layer covers the whole surface of the insulating substrate 110, and the pixel electrodes 190 are only arranged in the display area A.

The organic blocking member 199 is formed using the same layer of material used to form pixel electrode 190. The organic blocking member 199 spaced apart from the pixel electrode 190 with a predetermined distance and is located at the peripheral area B. The organic blocking member 199 overlaps the one side of the sealant 310 on which an injection hole 311 to inject a liquid crystal material is located.

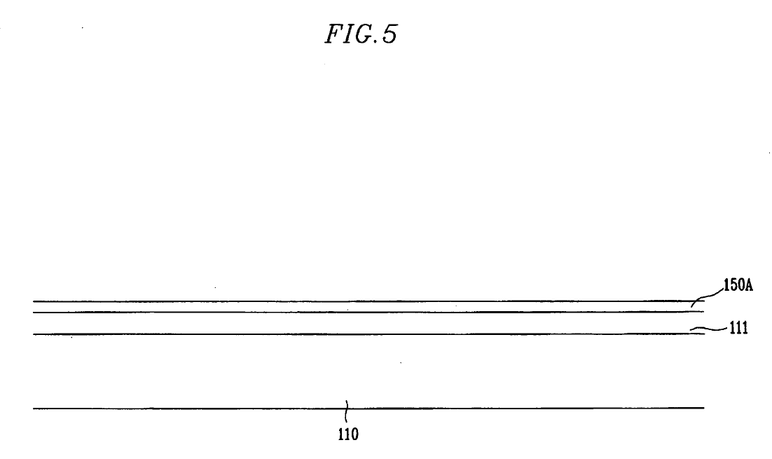

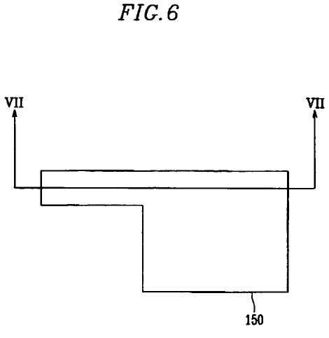

Now, a method of manufacturing the TFT array panel shown in FIGS. 1 to 4 according to an embodiment of the present invention will be now described in detail with reference to FIGS. 5 to 17 as well as FIGS. 1 to 4.

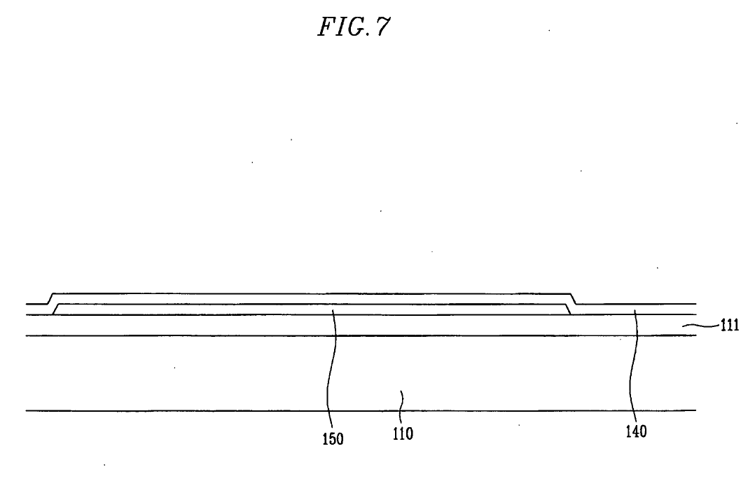

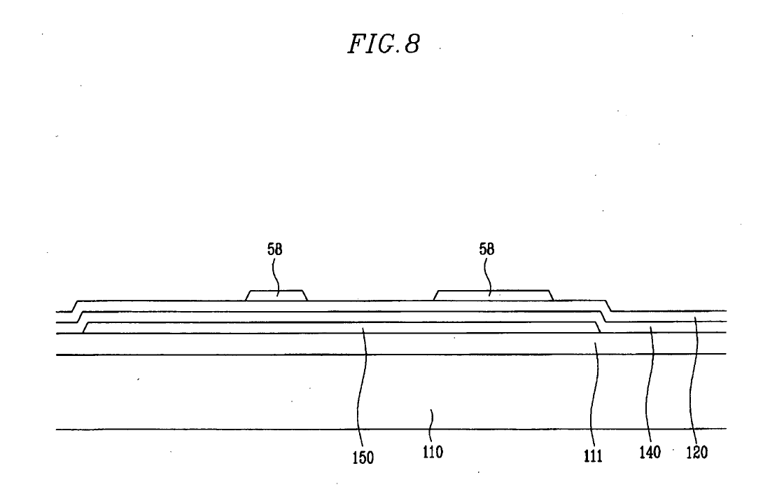

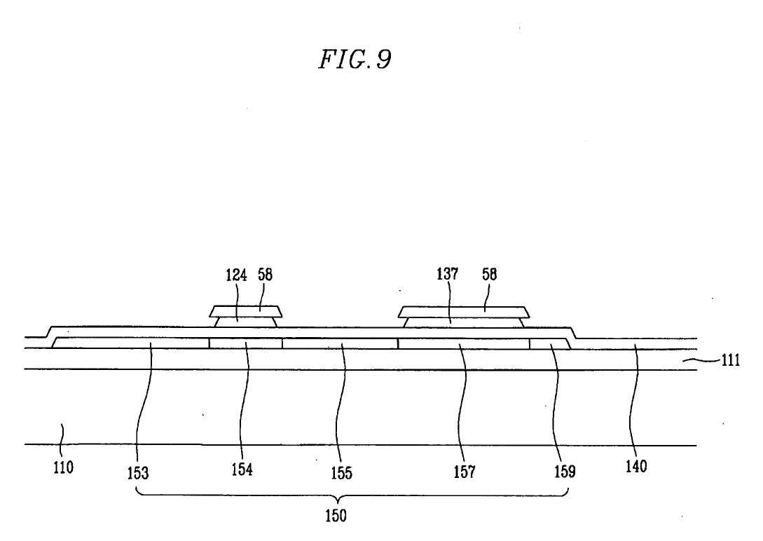

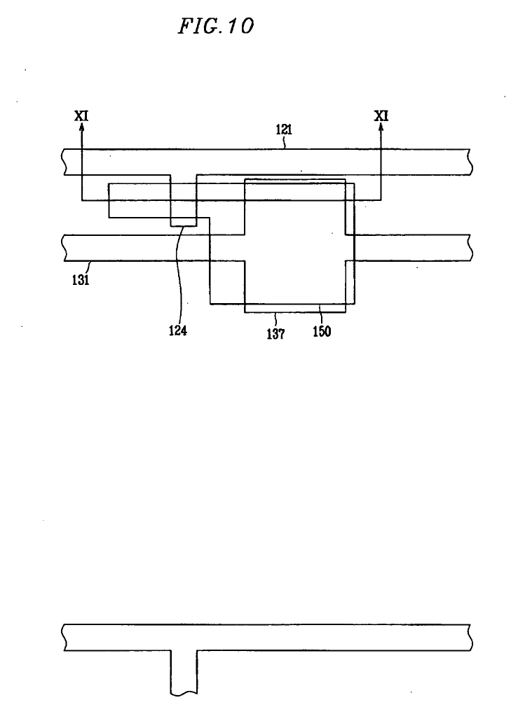

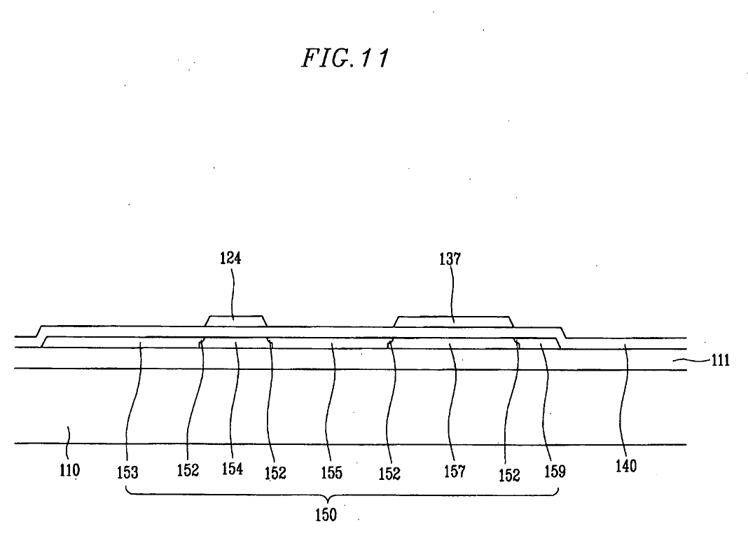

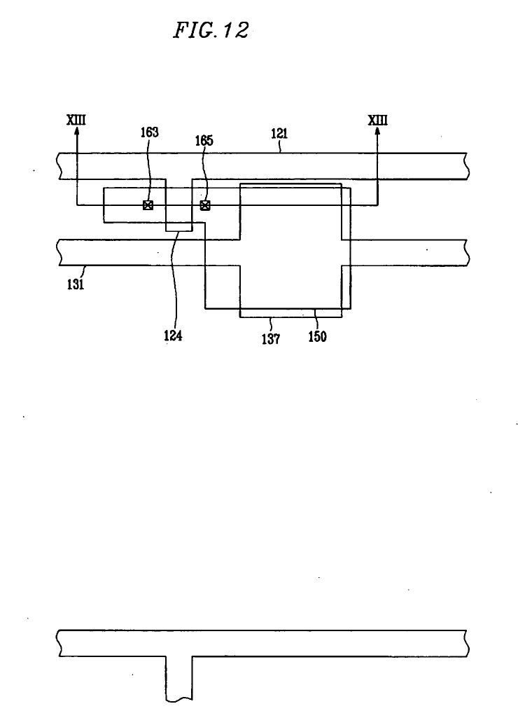

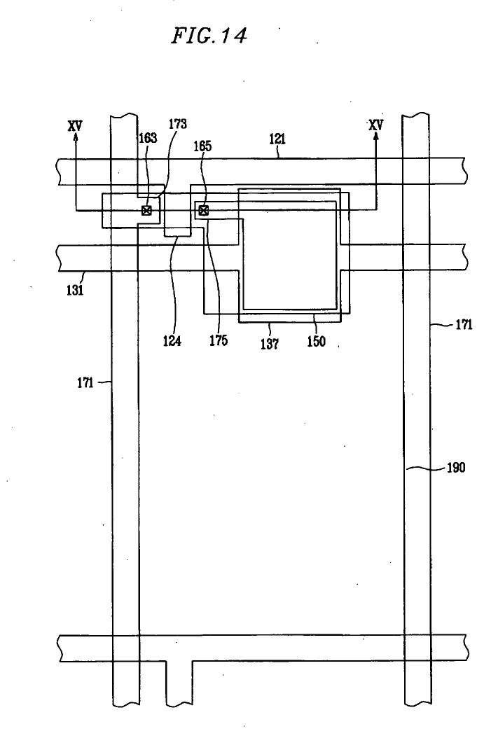

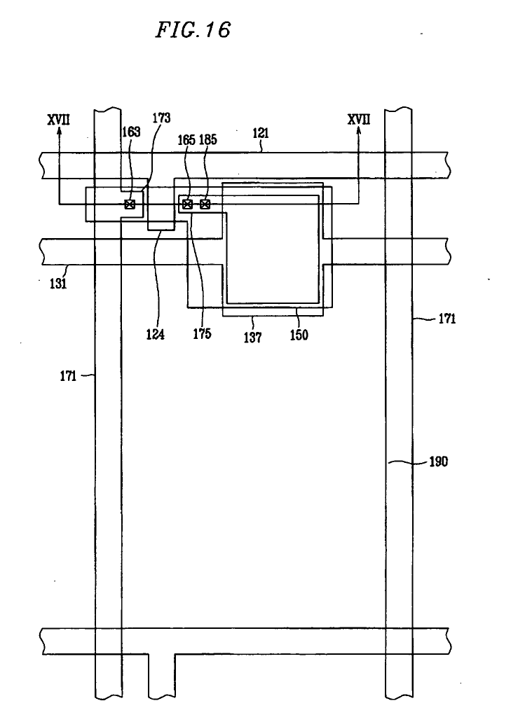

FIG. 5 is a cross sectional view of the TFT array panel shown in FIGS. 3 and 4 in the first step of a manufacturing method thereof according to an embodiment of the present invention, FIG. 6 is a layout view of the TFT array panel shown in FIGS. 3 and 4 in the first step of a manufacturing method thereof according to an embodiment of the present invention and illustrate the step following the step shown in FIG. 5, FIG. 7 is a sectional view of the TFT array panel shown in FIG. 6 taken along the line VII-VII, FIG. 8 a sectional view of the TFT array panel shown in FIG. 6 taken along the line VII-VII, and illustrates the step following the step shown in FIGS. 6 and 7, FIG. 9 is a sectional view of the TFT array panel shown in FIG. 6 taken along the line VII-VII; and illustrates the step following the step shown in FIG. 8, FIG. 10 is a layout view of the TFT array panel in the step following the step shown in FIG. 9, FIG. 11 is a sectional view of the TFT array panel shown in FIG. 10 taken along the line XI-XI, FIG. 12 is a layout view of the TFT array panel in the step following the step shown in FIGS. 10 and 11, FIG. 13 is a sectional view of the TFT array panel shown in FIG. 12 taken along the line XIII-XIII. FIG. 14 is a layout view of the TFT array panel in the step following the step shown in FIGS. 12 and 13, FIG. 15 is a sectional view of the TFT array panel shown in FIG. 14 taken along the line XV-XV, FIG. 16 is a layout view of the TFT array panel in the step following the step shown in FIGS. 14 and 15, and FIG. 17 is a sectional view of the TFT array panel shown in FIG. 14 taken along the line XVII-XVII.

Referring to FIG. 5, a blocking film 11 preferably made of silicon oxide (SiO₂) or silicon nitride (SiNx) is formed on an insulating substrate 110 such as transparent glass, quartz or sapphire. The blocking film 11 is deposited by LPCVD (low pressure chemical vapor deposition) or PECVD (plasma enhanced chemical vapor deposition). The LPCVD is executed in the deposition temperature of more than 550□, and the PECVD is executed using SiH4, SiF4 and H2 gas in the deposition temperature of less than 400□.

Next, an amorphous silicon layer 150A is formed on the blocking layer 111 using CVD.

The amorphous silicon layer 150A is then crystallized by laser annealing of SLS (sequential lateral solidification) mode to form a polysilicon layer 150.

The blocking layer 111 increases contact characteristics between the semiconductors 150 and the insulating substrate 110, and prevent impurities of the insulating substrate 110 from diffusing into the semiconductors 150 in a manufacturing process.

Referring to FIGS. 6 and 7, the polysilicon layer 150 is patterned by lithography and etching to form a plurality of semiconductor islands 150, and a gate insulating layer 140 preferably made of silicon oxide or silicon nitride is deposited with the thickness of about 600-1,800 Å by PECVD or LPCVD.

Referring to FIG. 8, a gate conductor film 120 preferably made of low resistivity material including Al containing metal such as Al and Al alloy (e.g. Al—Nd) is deposited on the gate insulating layer 140 and a conductive layer made of Cr is deposited on the gate conductor film 120. Next, a photoresist pattern is formed on the conductive layer and the conductive layer is etched using the photoresist pattern as an etch mask to form a plurality of doping masks 58 on the gate conductor film 120. The doping masks 58 are disposed on the semiconductor islands 150. The doping masks 58 have wider width than that of the gate electrode 124 (reference to FIG. 3 and 4) to define the width of LDD.

Referring to FIG. 9, the gate conductor film 120 is patterned by isotropic etch using the doping masks 58 as an etch mask to form a plurality of gate conductors that include a plurality of gate lines 121 including gate electrodes 124 and a plurality of storage electrode lines 131 including storage electrodes 137 on the semiconductor islands 150. The isotropic etch makes edges of the gate conductors 121 and 131 he within edges of the doping masks 58 with difference of the predetermined width, thereby being under cut structure. High-concentration impurity with N type or P type is introduced into the semiconductor islands 150 such that regions of the semiconductor islands 150 disposed under the doping masks 58 are not doped and remaining regions of the semiconductor islands 150 are heavily doped, thereby forming source and drain regions 153 and 155 and dummy regions 159 as well as channel regions 154 and storage regions 157.

Referring to FIGS. 10 and 11, after removing the doping mask 58, low-concentration impurity with N or P type is implanted with a high energy into the semiconductor islands 150 by using a scanning equipment or an ion beam equipment such that regions of the semiconductor islands 150 disposed under the gate conductors 121 and 131 are not doped and remaining regions of the semiconductor islands 150 are heavily doped to form lightly doped regions 152 at upper side portion of the channel regions 154 and the storage regions 157.

Next, the steps for forming the gate conductors 121 and 131 and for doping low or high concentration impurity with N or P type will be described in detail.

The gate conductor film 120 of a thin film transistor area of P type is patterned by lithography using a photoresist and etching to form a plurality of gate lines (not shown) of thin film transistor of P type, and the concentration impurity with P type is implanted into the semiconductor to form a source and a drain regions, and a channel region of thin film transistor with P type. At this time, an area in which thin film transistor with N type will be formed is covered and protected by the photoresist. Next, the photoresist is removed.

Then, a conductive layer for the doping mask 58 is formed on the gate conductor film 120, as above described. The doping mask 58 is used as an etch mask to the gate conductors 121 and 131, and as a doping mask to form the source and the drain regions 153 and 155. The conductive layer for the doping mask 58 may be etched along with the gate conductor film 120 using one etchant, and may be formed of metal having different etch rate with the respect to one etchant. In this embodiment, the conductive layer for the doping mask 58 made of Cr is used.

Next, the gate conductors 121 and 131 are formed, and form the source and the drain regions 153 and 155, and the lightly doped regions 152 are formed with defining the channel region 154. At this time, the area of thin film transistor with P type is covered and protected by the conductive layer for the doping mask 58. The process order for completing the thin film transistor with P and N type may be exchanged, and the method for forming the drain regions 153 and 155 and the lightly doped regions 152N may be various.

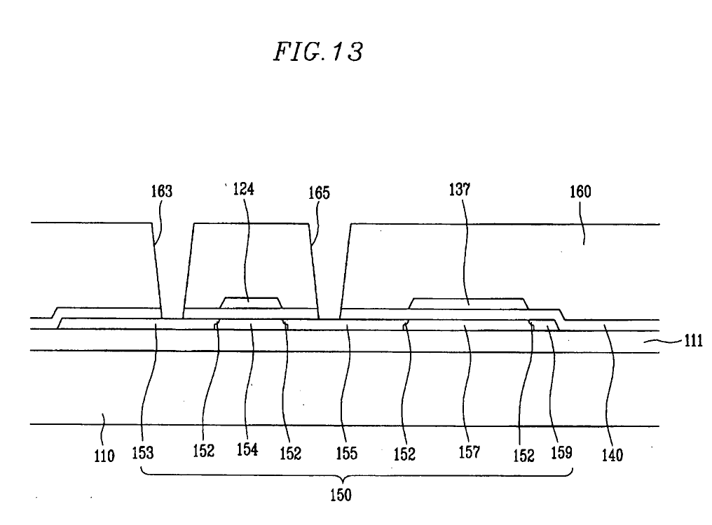

Referring to FIG. 12 and 13, an interlayer insulating layer 160 is deposited and patterned to form a plurality of contact holes 163 and 165 exposing the source regions 153 and the drain regions 155 along with the gate insulating layer 140. The interlayer insulating layer 160 may have double layered structure which SiO₂ and SiNx are sequentially deposited.

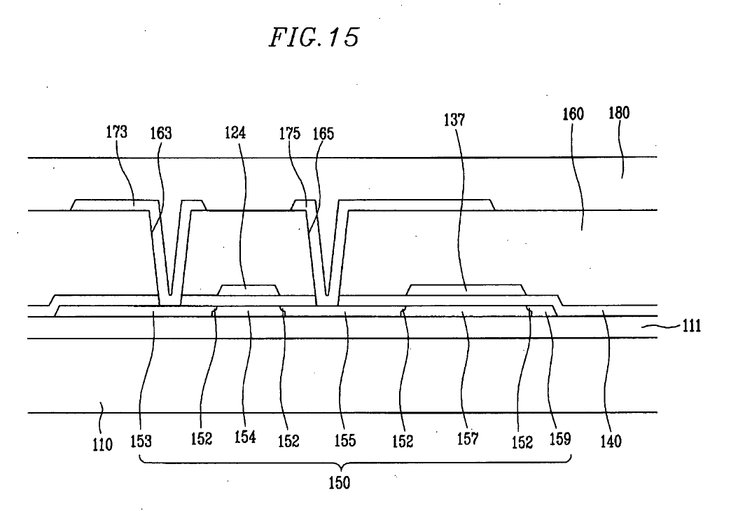

Referring to FIGS. 14 and 15, a plurality of data conductors including a plurality of data lines 171 including source electrodes 173 and a plurality of drain electrodes 175 are formed on the interlayer insulating layer 160. The source and the drain electrodes 173 and 175 are respectively connected to the source and the drain regions 153 and 155 through the contact holes 163 and 165. The gate lines 121 and the data lines 171 are intersected to each other to define a plurality of pixel area in which a plurality of pixel electrodes 190 lately. Next, a passivation layer 180 made of organic material is deposited. The passivation layer 180 covers the whole surface of the insulating substrate 110.

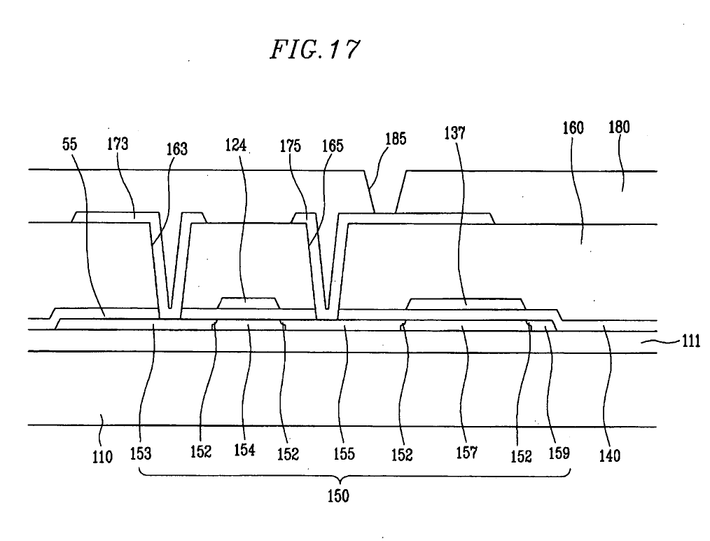

Referring to FIGS. 16 and 17, the passivation layer 180 is patterned to form a plurality of contact holes 185 exposing the drain electrode 175.

Referring to FIGS. 3 and 4, a plurality of pixel electrodes 190 are formed on the passivation layer 180 connected to the contact holes 175. At this time, an organic blocking member 199 is formed in the peripheral area B. The organic blocking member 199 is apart from the pixel electrode 190 with a determined distance and is located at the peripheral area B. The organic blocking member 199 is made of the same material as the pixel electrodes 190.

Next, a sealant 310 surrounding the display area A is formed on the passivation layer 180 in the peripheral area B of the lower panel 100. The one side of the sealant 310 overlaps the organic blocking member 199.

In detail, the sealant 310 includes four sides formed according to the four sides of the lower panel 100, and the organic blocking member 199 overlaps the one side of the sealant 310, on which the injection hole 311 is disposed.

Next, the upper panel 200 and the lower panel 100 are assembled and combined to each other, and a liquid crystal material is injected between the two panels 100 and 200. Next, a final sealant 320 made from a material which hardens based on the receipt of ultraviolet light is filled up at the injection hole 311, and the ultraviolet rays are irradiated to harden the final sealant 320.

As explained above, the organic blocking member 199 is located on the organic layer 180 on which the injection hole 311 of the sealant 310 and the final sealant 320 is formed. Accordingly, the organic blocking member 199 prevents the organic layer 180 neighboring the injection hole 311 from being exposed and damaged by ultraviolet irradiation to harden the final sealant 320. Furthermore, the organic blocking member 199 prevents spot defects generated by heat impact at the injection hole 311.

Additionally, the organic blocking member 199 may remove the organic material of the passivation layer 180, which is polluted by ultraviolet irradiation and is dissolved into the liquid crystal layer 3, by preventing the organic layer 180 neighboring the injection hole 311 from being damaged by ultraviolet irradiation, thereby enhancing a response time of liquid crystal and minimizing afterimages.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A thin film transistor array panel comprising:
a substrate having a display area including a plurality of pixel areas, and a peripheral area surrounding the display area;
a plurality of thin film transistors, one respectively formed in the plurality pixel areas;
a passivation layer of material covering the thin film transistors;
a plurality of pixel electrodes formed from a layer of material on the passivation layer in the pixel areas and being respectively connected to the thin film transistors;
an organic blocking member formed concurrently with the layer of material used to form the pixel electrodes, the organic blocking member being disposed in the peripheral area; and
a sealant extending around a periphery of the display area, the sealant being positioned on the passivation layer in the peripheral area,
wherein the organic blocking member overlaps the sealant.

2. The thin film transistor array panel of claim 1, wherein the organic blocking member is made of the same material as the pixel electrode.

3. The thin film transistor array panel of claim 1, wherein the sealant includes an injection hole.

4. The thin film transistor array panel of claim 3, wherein the organic blocking member overlaps a region of the sealant which includes the injection hole.

5. The thin film transistor array panel according to claim 1 where the passivation layer of material comprises an organic material.

6. A liquid crystal display comprising:
a first substrate having a display area including a plurality of pixel areas and a peripheral area surrounding the display area;
a plurality of thin film transistors, one respectively formed in the plurality pixel areas;
a passivation layer of material covering the thin film transistors;
a plurality of pixel electrodes formed from a layer of material on the passivation layer in the pixel areas and being respectively connected to the thin film transistors;
an organic blocking member formed concurrently with the layer of material used to form the pixel electrodes, the organic blocking member being disposed in the peripheral area; and
a sealant extending around a periphery of the display area, the sealant being positioned on the passivation layer in the peripheral area,
a second substrate having a surface facing the first substrate; and
a liquid crystal layer of material interposed between the first and the second substrates, and sealing by the sealant,
wherein the organic blocking member overlaps the sealant.

7. The liquid crystal display of claim 6, wherein the sealant includes an injection hole.

8. The liquid crystal display of claim 7, wherein the organic blocking member overlaps a region of the sealant which includes the injection hole.

9. The liquid crystal display of claim 7, further comprising a second sealant made of a material which is hardenable using ultraviolet light, the second sealant being positioned in the injection hole.

10. A method of manufacturing a liquid crystal display comprising:
forming a plurality of thin film transistors in a display area on a first substrate having a display area and the peripheral area surrounding the display area;
forming a passivation layer made of organic material on the thin film transistors;
forming a plurality of pixel electrode on the passivation layer of the display areas, and an organic blocking member in the peripheral area; and
forming a sealant enclosing the display area on the passivation layer of the peripheral area, wherein a portion of the sealant overlaps the organic blocking member.

11. The method of claim 10, further comprising:
assembling the first substrate and a second substrate facing the first substrate using the sealant;
injecting a liquid crystal material through an injection hole in the sealant between the first and the second substrates;
forming a final sealant at the injection hole; and
hardening the final sealant using ultraviolet rays.

12. The method of claim 11, wherein the organic blocking member is disposed on the injection hole.
